(19) United States
(12) Patent Application Publication
(10) Pub. No.: US 2007/0106746 A1
(43) Pub. Date: May 10, 2007

(54) Method and System Showing The Most Meaningful Page From A Book Or Content To Customers As The First Page

(75) Inventors: Sijian Zhang, Bellevue, WA (US); Yuanmeng Lu, Bellevue, WA (US)

Correspondence Address: Sijian Zhang, 5708 140th Place SE, Bellevue, WA, 98006, US

(73) Assignee: Sijian Zhang, Bellevue, WA (US)

(21) Appl. No.: 11/163,974

(22) Filed: Nov. 4, 2005

(51) Int. Cl. G06F 15/16

(52) U.S. Cl. 709/217

(57) ABSTRACT

Showing the most meaningful page as the first page of a book or content to the potential customer gives the customer a special first impression on the book or content. The present invention has significant impacts on the customer interest and purchase decision for the book or content. The present invention is disclosed, wherein by computing the historical statistics numbers for every page of the book or content as the pages meaningfulness measurements, selecting the page which has the largest statistics number and presenting the page to the customer first ahead of other less meaningful pages, and therefore giving the better customer's first impression on the book or content.

### BACKGROUND OF THE INVENTION

In the physical world, the customer in a bookstore often opens a book, randomly select a few pages to read before he or she decides to buy it. The selection of those pages, particularly the first page, is rather random.

The Internet age enables to sell books or contents, either in a physical form or a digital form, to the customers over a computer network such as the Internet. To assist the customers to buy the books, the e-commerce website may allow the potential online customers to view a number of pages of the book or content in digital forms (such as digital image). However, the selection of the viewable pages to display, particularly the first page, is either random or pre-determined without taking the customers' historical data into account.

In some cases, only one page from the book or content is allowed to display. This requires us to select the most meaningful page of the book or content.

This invention presents a system which may employ one or more of the three methods for determining and selecting the most meaningful page, in terms of customer statistics, as the first page to show to the customer whenever the customer sends a general request to see the book or content. The potential benefits for the sellers with this special first impression are, but not limit to, (a) help increasing the sales of the book or content, (b) reduce the time for the customer to make the purchase decision, and (c) reduce the computer network traffic cost and other costs for selling the book or content to a new customer.

### SUMMARY OF THE INVENTION

The present invention provides three possible methods in a system to select the most meaningful page from a book or content which has plural pages, and then display the selected page, as the first page, to the potential customers who show interest to buy the book or content.

An embodiment of the technology for displaying the most meaningful page in the present invention is transmitting the page image over the computer network such as the Internet, from the seller's server to the customer's computer, and then display on the customer's computer screen. The customer may initiate an online order process after seeing the displayed page.

An embodiment of the most meaningful page is the page which most of the previous customers made the purchase decision after viewing the page.

In another embodiment, the most meaningful page is the most representative page for the book or content based on the prior votes or reviews from the readers or customers.

In another embodiment, the most meaningful page is the page, from the book or content, which is the most relevant to the customer's personalization information such as the customer's used search terms.

One aspect of the present invention is a computer system or server that provides the storage for the digitalized pages of the book or content, the collection and statistics computation of the meaningfulness for every page of the book or content, and the selection and transmission of the most meaningful page.

### BRIEF DESCRIPTION OF THE DRAWINGS

FIG. 1 is a flow diagram illustrating the steps of processing the customer's general request for viewing a book or content.

FIG. 2 is an illustration diagram of the present invention wherein the most meaningful page is selected from the book or content which has plural pages, and sent to the display screen first.

FIG. 3 is a module diagram describing the system or server which supports the present invention.

FIG. 4 is a diagram depicting a way for soliciting customer votes on the page representative of the book or content.

### DETAILED DESCRIPTION OF THE PREFERRED EMBODIMENTS

The preferred embodiment of the present invention consists of, but not limit to, a sequence of these steps: (1) a customer visits an e-commerce website via a computer network, (2) the customer clicks on a product icon of a book or content, (3) the e-commerce website's server selects the most meaningful page based on one of the measurements below and sends it to the customer's display screen, (4) the customer may proceed with a purchase order after seeing the page.

The meaningfulness of a page in the book or content is measured based on the customers' history data related to the book or content, and optionally the customer's personalized information collected by the system. The most meaningful page of the book or content is the page which has the largest meaningfulness measurement value among all the pages of the book or content. Three types of page meaningfulness measurements are defined in the following paragraphs.

An embodiment of the meaningfulness statistics measurement for a page is the number of the prior customers who read the page and then purchased the book or content. We define P(i) is the number of the customers who read the i-th page of the book or content and purchased the book or content. So for the book or content which has N pages, we compute N numbers of historical purchase statistics for the N pages: P(1), P(2), . . . , P(N). Among the N numbers, assume P(j) is the largest number; thereby, the j-th page of the book or content is selected as the first page to be shown to the future customer first when the customer requests the detailed information about the book or content.

The customer's purchase decision after seeing the most meaningful page can be added to the page's historical data in the database for computing the new statistics for every page of the book or content in the future.

Another embodiment of the meaningfulness statistics measurement for a page is the number of customers' positive votes for the page representative of the book or content. Voting may happen in separate events. We define V(i) is the number of the customers who voted the i-th page of the book or content as the representative page of the book or content. So for the book or content which has N pages, we compute N numbers of statistics for the N pages: V(1), V(2), . . . , V(N), from the voting history. Among the N numbers, assuming V(j) is the largest number; thereby, the j-th page is selected as the first page to be shown to the future customer first when the customer requests the general information about the book or content. FIG. 4 depicts an embodiment of the implementation for soliciting the customer votes.

Another embodiment of the meaningfulness statistics measurement is the computed relevancy of the page of the book or content with respect to the customer's personalized information such as the search words which the customer used in the past. An measurement of the relevancy may be computed by counting the number of the words on the page appearing in the set of the search words which the customer used before in the system. We define R(i) is the relevancy numeric value of the i-th page with respect to the customer's personalized information. So for the book or content which has N pages, we compute N number of relevancy values: R(1), R(2), . . . , R(N), for that particular customer. Among the N numbers, assuming R(j) is the largest number; thereby, the j-th page is selected as the first page to be shown to the customer first when the customer requests the detailed information about the book or content.

When there are more than one pages of the book or content have the same largest value in the meaningfulness statistics measurement, the system may select any of the page from the set of the pages which have the same largest measurement values and send it first to the customer.

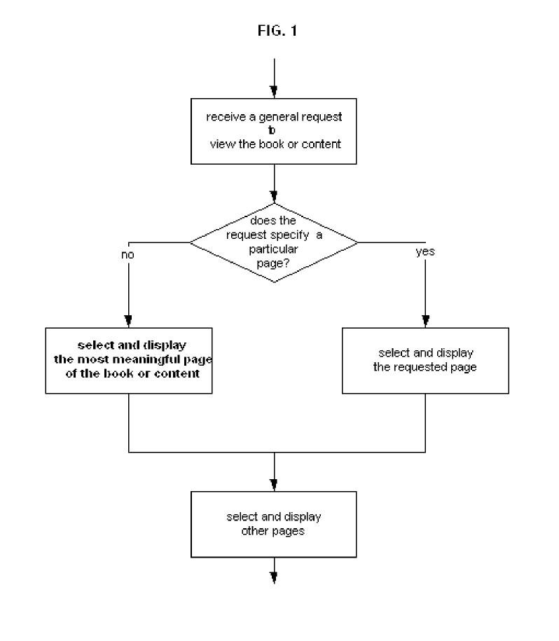

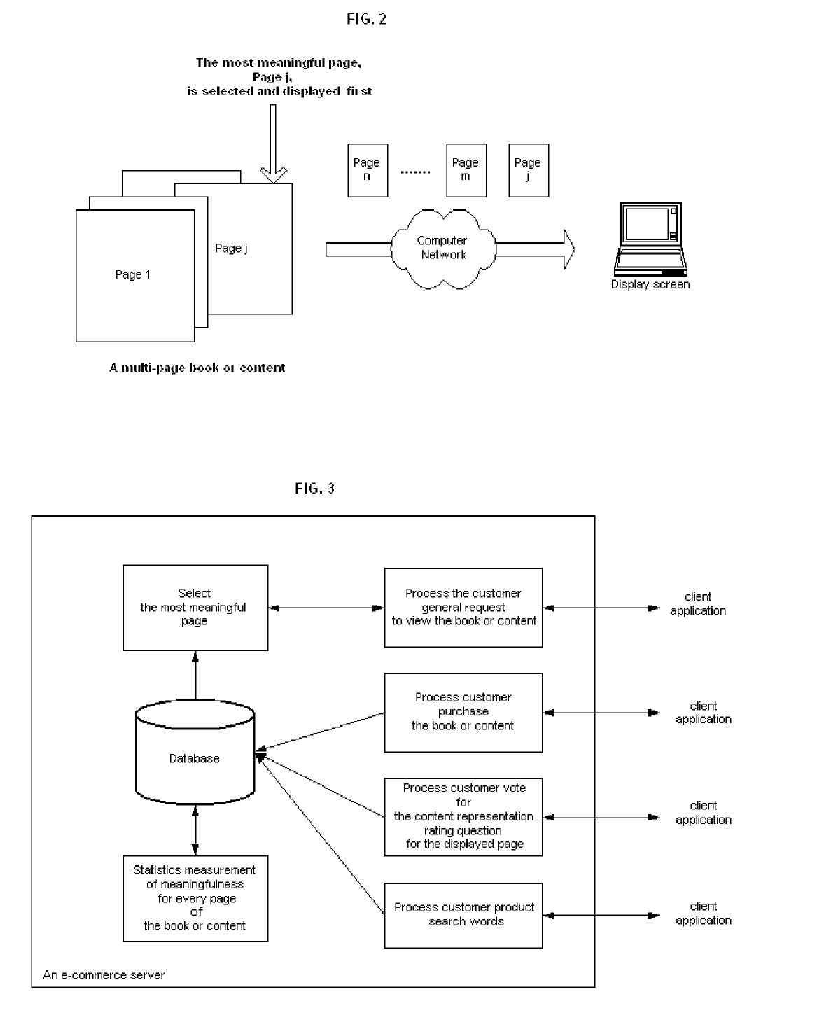

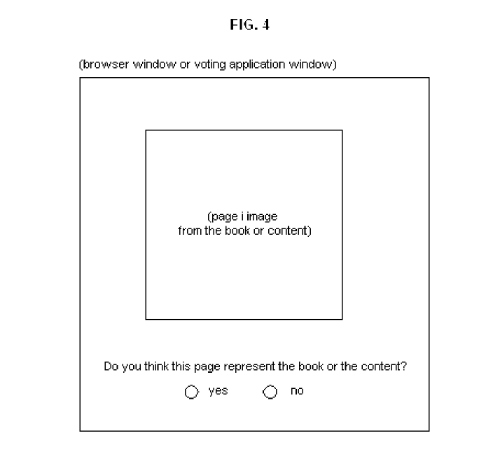

FIG. 1 illustrates the selection and sending of pages from a book or content for the present invention. Page j is selected to send and display first if it is the most meaningful page for the book or content that has plural pages. FIG. 2 depicts the selection flow. FIG. 3 shows an embodiment of one server implementation of the present invention. Database stores pages of the book or content and their meaningful measurements; database can be a real relational database or a set of flat files in a computer file system.

What is claimed is:

1. The non-random selection of the first page from a book or content which has a plurality of pages, comprising: (a) acquiring the meaningfulness measurements of every page of the book or content; (b) ranking the pages based on their collected or computed statistics; (c) identifying the most meaningful page of the book or content; (d) sending and displaying the most meaningful page first to the customer over the computer network.

2. The method of claim 1, wherein the most meaningful page is selected based on the statistics measurements using customers' historical data.

3. The method of claim 1, wherein the most meaningful page is sent and displayed first compared to other pages of the book or content.

4. The method of claim 2, wherein the most meaningful page is computed using customer purchase history and the book or content pages viewed by the customers.

5. The method of claim 2, wherein the most meaningful page is computed using the votes from the customers who viewed and then voted on the page representative survey for the book or content.

6. The method of claim 2, wherein the most meaningful page is computed using the relevancy with respect to the customer's personalized information collected in the past.
